(19) United States
(12) Patent Application Publication
(10) Pub. No.: US 2026/0172791 A1
(43) Pub. Date: Jun. 18, 2026

(54) INTEGRATED TARGET SENSING AND TRACKING IN 5G NETWORKS

(71) Applicant: TIAMI NETWORKS INC., Elk Grove, CA (US)

(72) Inventor: Amitav Mukherjee, Elk Grove, CA (US)

(73) Assignee: TIAMI NETWORKS INC., Elk Grove, CA (US)

(21) Appl. No.: 19/418,892

(22) Filed: Dec. 12, 2025

Related U.S. Application Data
(60) Provisional application No. 63/730,990, filed on Dec. 12, 2024.

(51) Int. Cl. H04W 4/38; H04L 1/00; H04W 64/00; H04W 76/15

(52) U.S. Cl. CPC H04W 4/38; H04L 1/0071; H04W 64/006; H04W 76/15

(57) ABSTRACT

According to an aspect of the present disclosure, a method of integrated target sensing and tracking in a 5G (fifth generation) cellular network is performed in a sensing entity in the 5G cellular network. The method comprise receiving wireless signals on a plurality (two or more) of frequencies; estimating, for each frequency of the plurality of frequencies, a per-frequency value for a set of sensing parameters related to a target based on the wireless signals received on the frequency; and calculating a final value for each sensing parameter of the set of sensing parameters based on the per-frequency values estimated for the sensing parameter corresponding to the plurality of frequencies.

### PRIORITY CLAIM

The instant patent application is related to and claims priority from the U.S. Provisional Application no: 63/730,990, Filed on: 12DEC. 2024, entitled, “MULTI-FREQUENCY INTEGRATED SENSING AND COMMUNICATION”, which is incorporated in its entirety herewith.

### BACKGROUND

### Technical Field

The disclosed embodiment is in the technical field of wireless communications, and more specifically to integrated target sensing and tracking in 5G (“fifth generation”) cellular networks.

### Description of the Related Art

Integrated Sensing and Communication (ISAC) is a common solution that utilizes a single wireless network and corresponding radio frequency signals to simultaneously communicate data packets and perform radar sensing. Current ISAC signal processing focuses on a single RF (Radio Frequency) channel. Current ISAC also does not specify mechanisms for selecting or allocating frequency channels.

802.11bf standard introduces capabilities for both sub-7GHz and 60GHz bands but the standard does not specify the choice of radio channels. Certain frequency channels have low bandwidth (lower radar sensing resolution) and low propagation loss, while other frequency channels have high bandwidth (better sensing resolution) and also high propagation loss.

Therefore, there is an urgent need to develop a method that intelligently manages ISAC over multiple frequencies.

### SUMMARY

The following presents a simplified summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

According to an aspect of the present disclosure, a method of integrated target sensing and tracking in a 5G (fifth generation) cellular network is performed in a sensing entity in the 5G cellular network. The method comprise receiving wireless signals on a plurality (two or more) of frequencies; estimating, for each frequency of the plurality of frequencies, a per-frequency value for a set of sensing parameters related to a target based on the wireless signals received on the frequency; and calculating a final value for each sensing parameter of the set of sensing parameters based on the per-frequency values estimated for the sensing parameter corresponding to the plurality of frequencies.

According to another aspect of the present disclosure, the set of sensing parameters comprises target location, velocity, heading, and other parameters related to target detection, classification, and tracking.

According to one more aspect of the present disclosure, the final value for each sensing parameter is obtained as: (A) an average of the per-frequency values estimated for the sensing parameter corresponding to the plurality of frequencies; or (B) a weighted combination of the per-frequency values estimated for the sensing parameter corresponding to the plurality of frequencies, wherein the weighting factor for each frequency is determined based on the signal quality or bandwidth of the frequency.

According to yet another aspect of the present disclosure, the time-domain granularity of the per-frequency values is different for each frequency, wherein the final value is calculated by interleaving or interpolating the per-frequency values estimated for the sensing parameter corresponding to the plurality of frequencies in the time domain.

According to a further aspect of the present disclosure, the sensing entity simultaneously establishes data communication links with a wireless device on the plurality of frequencies, while also using the plurality of frequencies for target sensing and tracking.

According to another aspect of the present disclosure, the sensing entity comprises an Integrated Sensing and Communication (ISAC) block, 802.11bf block, 3GPP 5G block, radar sensor, radio wave system, and multi-band device.

According to one more aspect of the present disclosure, the sensing entity is one of a base station, a user equipment, or a device in the 5G cellular network.

Thus, aspects of the present disclosure involve methods to manage ISAC network capabilities across multiple radio frequencies at a single network node (sensing entity).

Several aspects of the disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### BRIEF DESCRIPTION OF THE DRAWINGS

Example embodiments of the disclosure will be described with reference to the accompanying drawings briefly described below.

FIG. 1 is a block diagram illustrating an example environment (computing system) in which several aspects of the present disclosure can be implemented.

FIG. 2 is a flow chart illustrating the manner in which integrated target sensing and tracking in 5G cellular networks is facilitated according to the aspects of the disclosed embodiment.

FIG. 3 is a block diagram illustrating the details of a digital processing system in which various aspects of the present disclosure are operative by execution of appropriate execution modules, according to the aspects of the disclosed embodiment.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

Reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another.

As used herein, the singular forms “a”, “an”, and “the” include both singular and plural referents unless the context clearly dictates otherwise. By way of example, “a dosage” refers to one or more than one dosage. The terms “comprising”, “comprises” and “comprised of” as used herein are synonymous with “including”, “includes” or “containing”, “contains”, and are inclusive or open-ended and do not exclude additional, non-recited members, elements, or method steps.

All documents cited in the present specification are hereby incorporated by reference in their totality. In particular, the teachings of all documents herein specifically referred to are incorporated by reference.

Example embodiments of the present disclosure are described with reference to the accompanying figures.

### 1. Definitions

The term “IEEE 802.11bf”′ refers a standard to improve Wireless Local Area Network (WLAN) sensing—the process of using wireless signals to identify characteristics of people and objects in a particular environment—by enhancing the Wi-Fi standard.

The term “3GPP (Third Generation Partnership Project)” refers to provide the foundation for the development of new technologies such as 5G, broadband, IoT devices.

The term “ISAC (Integrated Sensing and Communication)” refers to the technologies that combine sensing and communication systems to utilize wireless resources efficiently, realize wide area environment sensing, and even to pursue mutual benefits.

The term “multi-band device” refers to a communication device that supports multiple radio frequency bands.

The term “sub-6GHz” refers to the frequency range below 6 GHz in the radio spectrum. This frequency range helps to provide wireless services such as 4G, LTE, 5G and Wi-Fi.

The term “sub-7GHz” refers to a range of radio frequencies that can be used for a variety of applications, including wireless communication, RF signal path switching, and more.

The term “60 GHz” refers to the frequency range between 54-71 GHz.

### 2. Example Environment

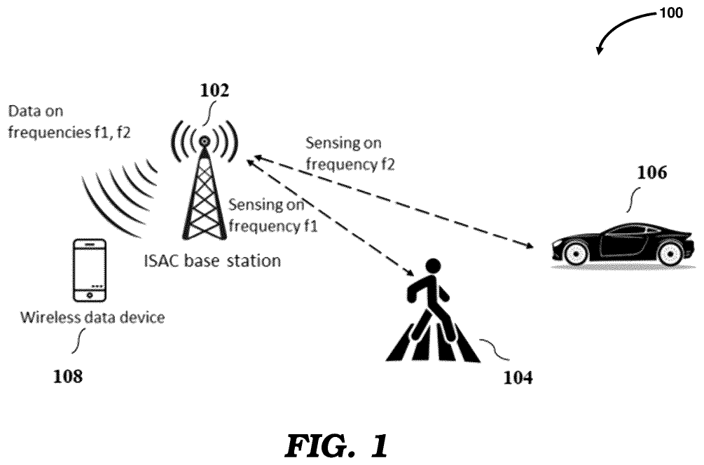

FIG. 1 is a block diagram illustrating an example environment (computing system) in which several aspects of the present disclosure can be implemented. 100 illustrates a wireless communication system (5G network) for integrated target sensing and tracking.

Base station 102 is an ISAC enabled device capable of sensing as well as communication. The ISAC frequency selection logic at base station 102 determines which frequency to use for specific applications based on factors like transmit powers, available bandwidth, congestion levels, and propagation losses. For illustration, the description is continued assuming that base station 102 represents a sensing entity implementing the aspects of the present disclosure, though in other embodiments, the same aspects can be implemented when the sensing entity is a user equipment (such as 108) or any other device (not shown) in the 5G network (100).

Wireless data device 108 refer to a user entity (UE) device such as smartphones, tablets, and IoT devices that connect to 5G cellular networks (via base station 102) to access services. Targets 104 and 106 refer to objects that are sought to be detected, classified or tracked by base station 102.

Aspects of the present disclosure are directed to integrated target sensing and tracking in such an environment (100) as described in detail below.

### 3. General Flow

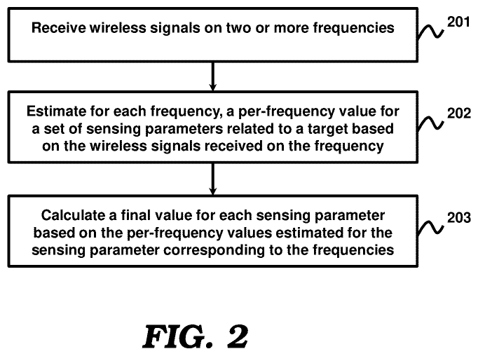

FIG. 2 is a flow chart illustrating the manner in which beamforming for sensing and tracking a target in 5G cellular networks is facilitated according to the aspects of the disclosed embodiment. The flowchart is described with respect to FIG. 1, in particular base station 102 (sensing entity) merely for illustration. However, various features can be implemented in other systems and/or other environments also without departing from the scope of various aspects of the present invention, as will be apparent to one skilled in the relevant arts by reading the disclosure provided herein.

In addition, some of the steps may be performed in a different sequence than that depicted below, as suited in the specific environment, as will be apparent to one skilled in the relevant arts. Many of such implementations are contemplated to be covered by several aspects of the present invention.

In step 201, base station 102 receives wireless signals on two or more frequencies. According to an aspect, base station 102 simultaneously establishes data communication links with a wireless device (such as 108) on the two or more frequencies, while also using the same frequencies for target sensing and tracking.

In step 202, base station 102 estimates for each frequency, a per-frequency value for a set of sensing parameters related to a target based on the wireless signals received on the frequency. According to an aspect, the set of sensing parameters includes target location, velocity of the target, heading of the target, and other parameters related to target detection, classification, and tracking.

In step 203, base station 102 calculates a final value for each sensing parameter based on the per-frequency values estimated for the sensing parameter corresponding to the frequencies. According to an aspect, the final value for each sensing parameter is obtained as: (A) an average of the per-frequency values estimated for the sensing parameter corresponding to the different frequencies; or (B) a weighted combination of the per-frequency values estimated for the sensing parameter corresponding to the different frequencies, wherein the weighting factor for each frequency is determined based on the signal quality or bandwidth of the frequency.

According to another aspect, the time-domain granularity of the per-frequency values is different for each frequency. As such, the final value is calculated by interleaving or interpolating the per-frequency values estimated for the sensing parameter corresponding to the different frequencies in the time domain.

Thus, base station 102 simultaneously establishes data communication links with a wireless device (108) on frequency channels f1 and f2, while also using the same frequency channels f1 and f2 for radar sensing of pedestrians (104) and vehicles (106) respectively. Radar sensing in the context of ISAC may refer to one or more of the following: detection of the presence of an object in the environment, classification of the type of object detected, tracking the position and velocity of the object.

Different frequencies can be selected for tracking vehicles, unmanned aerial vehicles, and human activity recognition. The system (102) can also support the same or various radio access technologies on different frequencies, such as 5G and Wi-Fi. Multiple frequencies can be employed simultaneously in the ISAC system without loss of any generality. For example, a sub-6 GHz frequency channel with long-range coverage may be selected for tracking vehicles and empty aerial vehicles, while a 30 GHz millimeter-wave frequency channel with a large bandwidth may be selected for short-range human activity recognition.

According to an aspect, base station 102 comprises an Integrated Sensing and Communication (ISAC) block, 802.11bf block, 3GPP 5G block, radar sensor, radio wave system, and multi-band device.

### 4. Uses, Applications and Benefits of the Disclosure

The instant disclosure reduces downtime, and incidents are addressed correctly and with minimum potential damage. Without any concern the process will complete, as it can detect whichever network the objects are connected to. The instant disclosure reduces complexity and ranging from security breaches to operational disruption.

The instant disclosure is used in various sectors for their safety and security measures. Mostly used in tracking position, velocity of the object, and object detection. Common use cases include detection and tracking of vehicles traveling on highways or city streets, detection and tracking of pedestrians, occupancy sensing and crowd counting in indoor environments, and detection and tracking of unmanned aerial vehicles (e.g., drones).

Best mode to practice the present disclosure is which simplifies the method of multi-frequency integrated sensing and communication by including this feature in next generation wireless communications devices and equipment such as smartphones, wireless access points, base stations, and Internet of Things (IoT) devices.

It should be appreciated that the above noted features can be implemented in various embodiments as a desired combination of one or more of hardware, execution modules, and firmware. The description is continued with respect to one embodiment in which various features are operative when execution modules are executed.

### 5. Hardware

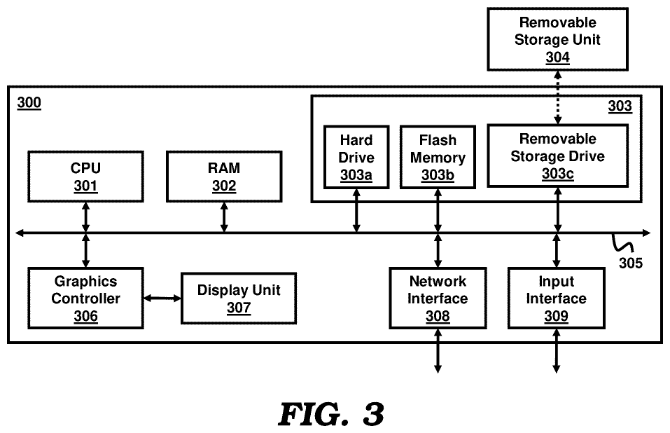

FIG. 3 is a block diagram illustrating the details of digital processing system (300) in which various aspects of the present invention are operative by execution of appropriate execution modules. Digital processing system 300 may correspond to any of base station (such as 102) or user equipment (such as 108) in the 5G cellular network.

Digital processing system 300 may contain one or more processors (such as a central processing unit (CPU) 301), random access memory (RAM) 302, secondary memory 303, graphics controller 306, display unit 307, network interface 308, and input interface 309. All the components except display unit 307 may communicate with each other over communication path 305 which may contain several buses as is well known in the relevant arts. The components of FIG. 3 are described below in further detail.

CPU 301 may execute instructions stored in RAM 302 to provide several features of the present invention. CPU 301 may contain multiple processing units, with each processing unit potentially being designed for a specific task. Alternatively, CPU 301 may contain only a single general-purpose processing unit. RAM 302 may receive instructions from secondary memory 303 using communication path 305.

Graphics controller 306 generates display signals (e.g., in RGB format) to display unit 307 based on data/instructions received from CPU 301. Display unit 307 contains a display screen to display the images defined by the display signals. Input interface 309 may correspond to a keyboard and a pointing device (e.g., touch-pad, mouse), which enable the various inputs to be provided.

Network interface 308 provides connectivity to a network (e.g., using Internet Protocol), and may be used to communicate with other connected systems. Network interface 308 may provide such connectivity over a wire (in the case of TCP/IP based communication) or wirelessly (in the case of WIFI, Bluetooth based communication).

Secondary memory 303 may contain hard drive 303a, flash memory 303b, and removable storage drive 303c. Secondary memory 303 may store the data (e.g., estimated per-frequency value and calculated final value for the set of sensing parameters) and software instructions (e.g., for implementing the steps of FIG. 2), which enable digital processing system 300 to provide several features in accordance with the present invention.

Some or all of the data and instructions may be provided on removable storage unit 304, and the data and instructions may be read and provided by removable storage drive 303c to CPU 301. Floppy drive, magnetic tape drive, CD-ROM drive, DVD Drive, Flash memory, removable memory chip (PCMCIA Card, EPROM) are examples of such removable storage drive 303c.

Removable storage unit 304 may be implemented using storage format compatible with removable storage drive 303c such that removable storage drive 303c can read the data and instructions. Thus, removable storage unit 304 includes a computer readable storage medium having stored therein computer software (in the form of execution modules) and/or data.

However, the computer (or machine, in general) readable storage medium can be in other forms (e.g., non-removable, random access, etc.). These “computer program products” are means for providing execution modules to digital processing system 300. CPU 301 may retrieve the software instructions (forming the execution modules) and execute the instructions to provide various features of the present invention described above.

Merely for illustration, only representative number/type of graph, chart, block, and sub-block diagrams were shown. Many environments often contain many more block and sub-block diagrams or systems and sub-systems, both in number and type, depending on the purpose for which the environment is designed.

While specific embodiments of the invention have been shown and described in detail to illustrate the inventive principles, it will be understood that the invention may be embodied otherwise without departing from such principles.

The figures and/or screen shots shown highlighting the functionality and advantages of the present invention are presented for example purposes only. The present invention is sufficiently flexible and configurable, such that it may be utilized in ways other than that shown in the figures.

The examples and embodiments described herein are for illustrative purposes only and that various modifications or changes in light thereof will be suggested to persons skilled in the art and are to be included within the spirit and purview of this application and scope of the appended claims.

What is claimed is:

1. A method of integrated target sensing and tracking in a 5G (fifth generation) cellular network, the method being performed in a sensing entity in the 5G cellular network, the method comprising:
receiving wireless signals on a plurality of frequencies;
estimating, for each frequency of the plurality of frequencies, a per-frequency value for a set of sensing parameters related to a target based on the wireless signals received on the frequency; and
calculating a final value for each sensing parameter of the set of sensing parameters based on the per-frequency values estimated for the sensing parameter corresponding to the plurality of frequencies.

2. The method of claim 1, wherein the set of sensing parameters comprises target location, velocity, heading, and other parameters related to target detection, classification, and tracking.

3. The method of claim 1, wherein the final value for each sensing parameter is obtained as:
(A) an average of the per-frequency values estimated for the sensing parameter corresponding to the plurality of frequencies; or
(B) a weighted combination of the per-frequency values estimated for the sensing parameter corresponding to the plurality of frequencies, wherein the weighting factor for each frequency is determined based on the signal quality or bandwidth of the frequency.

4. The method of claim 1, wherein the time-domain granularity of the per-frequency values is different for each frequency, wherein the final value is calculated by interleaving or interpolating the per-frequency values estimated for the sensing parameter corresponding to the plurality of frequencies in the time domain.

5. The method of claim 1, wherein the sensing entity simultaneously establishes data communication links with a wireless device on the plurality of frequencies, while also using the plurality of frequencies for target sensing and tracking.

6. The method of claim 1, wherein the sensing entity comprises an Integrated Sensing and Communication (ISAC) block, 802.11bf block, 3GPP 5G block, radar sensor, radio wave system, and multi-band device.

7. The method of claim 1, wherein the sensing entity is one of a base station, a user equipment, or a device in the 5G cellular network.

8. A sensing entity in a 5G (fifth generation) cellular network to perform integrated target sensing and tracking in the 5G cellular network, the sensing entity configured to perform the actions of:
receiving wireless signals on a plurality of frequencies;
estimating, for each frequency of the plurality of frequencies, a per-frequency value for a set of sensing parameters related to a target based on the wireless signals received on the frequency; and
calculating a final value for each sensing parameter of the set of sensing parameters based on the per-frequency values estimated for the sensing parameter corresponding to the plurality of frequencies.

9. The sensing entity of claim 8, wherein the set of sensing parameters comprises target location, velocity, heading, and other parameters related to target detection, classification, and tracking.

10. The sensing entity of claim 8, wherein the final value for each sensing parameter is obtained as:
(A) an average of the per-frequency values estimated for the sensing parameter corresponding to the plurality of frequencies; or
(B) a weighted combination of the per-frequency values estimated for the sensing parameter corresponding to the plurality of frequencies, wherein the weighting factor for each frequency is determined based on the signal quality or bandwidth of the frequency.

11. The sensing entity of claim 8, wherein the time-domain granularity of the per-frequency values is different for each frequency, wherein the final value is calculated by interleaving or interpolating the per-frequency values estimated for the sensing parameter corresponding to the plurality of frequencies in the time domain.

12. The sensing entity of claim 8, wherein the sensing entity simultaneously establishes data communication links with a wireless device on the plurality of frequencies, while also using the plurality of frequencies for target sensing and tracking.

13. The sensing entity of claim 8, wherein the sensing entity comprises an Integrated Sensing and Communication (ISAC) block, 802.11bf block, 3GPP 5G block, radar sensor, radio wave system, and multi-band device.

14. The sensing entity of claim 8, wherein the sensing entity is one of a base station, a user equipment, or a device in the 5G cellular network.

15. A non-transitory machine-readable medium storing one or more sequences of instructions for integrated target sensing and tracking in a 5G (fifth generation) cellular network, wherein execution of said one or more instructions by one or more processors contained in a sensing entity in the 5G cellular network causes the sensing entity to perform the actions of:
receiving wireless signals on a plurality of frequencies;
estimating, for each frequency of the plurality of frequencies, a per-frequency value for a set of sensing parameters related to a target based on the wireless signals received on the frequency; and
calculating a final value for each sensing parameter of the set of sensing parameters based on the per-frequency values estimated for the sensing parameter corresponding to the plurality of frequencies.

16. The non-transitory machine-readable medium of claim 15, wherein the set of sensing parameters comprises target location, velocity, heading, and other parameters related to target detection, classification, and tracking.

17. The non-transitory machine-readable medium of claim 15, wherein the final value for each sensing parameter is obtained as:
(A) an average of the per-frequency values estimated for the sensing parameter corresponding to the plurality of frequencies; or
(B) a weighted combination of the per-frequency values estimated for the sensing parameter corresponding to the plurality of frequencies, wherein the weighting factor for each frequency is determined based on the signal quality or bandwidth of the frequency.

18. The non-transitory machine-readable medium of claim 15, wherein the time-domain granularity of the per-frequency values is different for each frequency, wherein the final value is calculated by interleaving or interpolating the per-frequency values estimated for the sensing parameter corresponding to the plurality of frequencies in the time domain.

19. The non-transitory machine-readable medium of claim 15, wherein the sensing entity simultaneously establishes data communication links with a wireless device on the plurality of frequencies, while also using the plurality of frequencies for target sensing and tracking.

20. The non-transitory machine-readable medium of claim 15, wherein the sensing entity comprises an Integrated Sensing and Communication (ISAC) block, 802.11bf block, 3GPP 5G block, radar sensor, radio wave system, and multi-band device, wherein the sensing entity is one of a base station, a user equipment, or a device in the 5G cellular network.
